(19) United States
(12) Patent Application Publication
(10) Pub. No.: US 2019/0286854 A1
(43) Pub. Date: Sep. 19, 2019

(54) RECORD PARAMETER AUTOMATIC ADJUSTING MACHINES AND METHODS

(71) Applicant: Fulton Financial Corporation, Lancaster, PA (US)

(72) Inventors: Avnish Patel, Lititz, PA (US); Amy Hartenstine, Mountville, PA (US)

(21) Appl. No.: 15/920,797

(22) Filed: Mar. 14, 2018

(51) Int. Cl. G06F 21/78; G06F 21/62

(52) U.S. Cl. CPC G06F 21/78; G06F 21/62

(57) ABSTRACT

A machine includes a processor. The machine includes a machine readable medium accessible by the processor. The machine includes a record stored in the machine readable medium. The record including a first parameter and a second parameter. The processor is adapted to execute instructions including setting a first threshold for the first parameter; evaluating an increase of the first parameter; and moving an amount of the increase of the first parameter excessive to the first threshold to the second parameter, wherein a summation of the first parameter and the second parameter remains the same before and after the movement. Further, the machine executes instruction including setting a second threshold for the second parameter; and stopping any movement of any portion of the first parameter to the second parameter, if the second parameter is equal or larger than the second threshold.

### FIELD OF INVENTION

The present disclosure generally relates to record parameter automatic adjusting machines and methods. More specifically, the embodiments disclosed herein are related to automatically adjusting parameters of various kinds of records according to specific rules.

### BACKGROUND OF THE INVENTION

Companies in modern industries have large amounts of electronic records recording various relationship among the companies themselves, their vendors, and their clients. For example, electronic records for the interactions between businesses, such as banks, lenders, credit card companies, cell phone companies, utilities, mortgage companies, finance companies, financial institutions, retail companies and their customers or in the interactions between a government and its citizens, financial data are generated. The relationships between a business and its customers can be of a temporary or a more permanent nature. As an example, a temporary relationship might result from a single purchase of a product or a service from a retail company. A more permanent relationship might result when a service provider, such as a bank or a utility company, provides services to customers on an ongoing basis and regularly communicates with its customers.

Two issues going hand-in-hand exist in keeping and processing these electronic records: resource efficiency and data security. For data security purposes, a single record is often parsed and encrypted in multiple pieces. This is done so because if one piece of data is hacked or compromised, the integrity of the entire record may stay intact because other pieces of data were not compromised. Further, different data pieces of the parsed record may be stored at different physical locations to increase the security. Keeping pieces of a record at different locations drastically increases the amount of data transmitted through internet. For example, when parameters of a record need to be adjusted, the data management console have to pull different data pieces of the record from different locations and transfer those data back to a central location to be reassembled and processed. After the record is processed, the console usually has to parse the record again and sent different data pieces back to various data centers. The transferring back-and-forth of a large amount of records often exhaust the internet bandwidth causing traffic congestion.

The embodiments disclosed herein provide solutions to reduce internet congestions yet keeping the records secure, striking a delicate balance between resource efficiency and data security. The embodiments disclosed herein provide automatic record parameter adjusting machines and methods such that when parameters of a records need to be adjusted, the adjustment can be done automatically among the data centers without sending data pieces to a central location for processing. More specifically, some embodiments are directed to automatic record parameter adjustments according to a set of predetermined rules. This allows the adjustment of record be done automatically among the data centers and avoids sending multiple pieces of data back and forth among data centers and the central location.

### SUMMARY OF THE INVENTION

The present disclosure generally relates to record parameter automatic adjusting machines and methods. More specifically, the embodiments disclosed herein are related to automatically adjusting parameters of various kinds of records according to specific rules.

According to an embodiment of the disclosure, a machine of console includes a processor and a machine readable medium accessible by the processor. The console includes a record stored in the machine readable medium. The record includes a first parameter and a second parameter. The processor is adapted to execute instructions including setting a first threshold for the first parameter; evaluating an increase of the first parameter; and moving an amount of the increase of the first parameter excessive to the first threshold to the second parameter, wherein a summation of the first parameter and the second parameter remains the same before and after the movement. Further, the machine executes instruction including setting a second threshold for the second parameter; and stopping any movement of any portion of the first parameter to the second parameter, if the second parameter is equal or larger than the second threshold.

According to an embodiment of the disclosure, a machine readable medium of a console includes a record stored in the machine readable medium. The record includes a first parameter and a second parameter. The machine readable medium further includes instructions when executed cause a processor of the console to perform the following actions: setting a first threshold for the first parameter; evaluating an increase of the first parameter; and moving an amount of the increase of the first parameter excessive to the first threshold to the second parameter, wherein a summation of the first parameter and the second parameter remains the same before and after the movement. Further, the machine readable memory medium includes instructions: setting a second threshold for the second parameter; and stopping any movement of any portion of the first parameter to the second parameter, if the second parameter is equal or larger than the second threshold.

Other objects, features and advantages disclosed herein will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description.

### BRIEF DESCRIPTION OF THE DRAWINGS

Advantages of the present invention may become apparent to those skilled in the art with the benefit of the following detailed description and upon reference to the accompanying drawings.

FIG. 1 is a block diagram of a secure storage system for storing electronic records according to one embodiment of the disclosure.

FIG. 2A is a block diagram depicting an implementation of secure data storage in the system according to one embodiment of the disclosure.

FIG. 2B is a block diagram depicting an implementation of secure data storage in the system according to one embodiment of the disclosure.

FIG. 2C is a block diagram depicting an implementation of secure data storage in the system according to one embodiment of the disclosure.

FIG. 3 shows an example of automatic parameter adjusting of a record stored at a storage location according to one embodiment of the disclosure.

FIG. 4 shows an example of automatic parameter adjusting of two records stored at different locations according to one embodiment of the disclosure.

FIG. 5 shows a method of automatic parameter adjusting of records according to one embodiment of the disclosure.

FIG. 6 shows a method of automatic parameter adjusting of records according to one embodiment of the disclosure.

FIG. 7 illustrates a computer network for obtaining access to database files in a computing system according to one embodiment of the disclosure.

FIG. 8 illustrates a computer system adapted according to certain embodiments of the server and/or the user interface device according to one embodiment of the disclosure.

FIG. 9A is a block diagram illustrating a server hosting an emulated software environment for virtualization according to one embodiment of the disclosure.

FIG. 9B is a block diagram illustrating a server hosting an emulated hardware environment according to one embodiment of the disclosure.

While the invention is susceptible to various modifications and alternative forms, specific embodiments thereof are shown by way of example in the drawings. The drawings may not be to scale.

### DETAILED DESCRIPTION OF THE INVENTION

While the invention is susceptible to various modifications and alternative forms, specific embodiments thereof are shown by way of example in the drawings. The drawings may not be to scale.

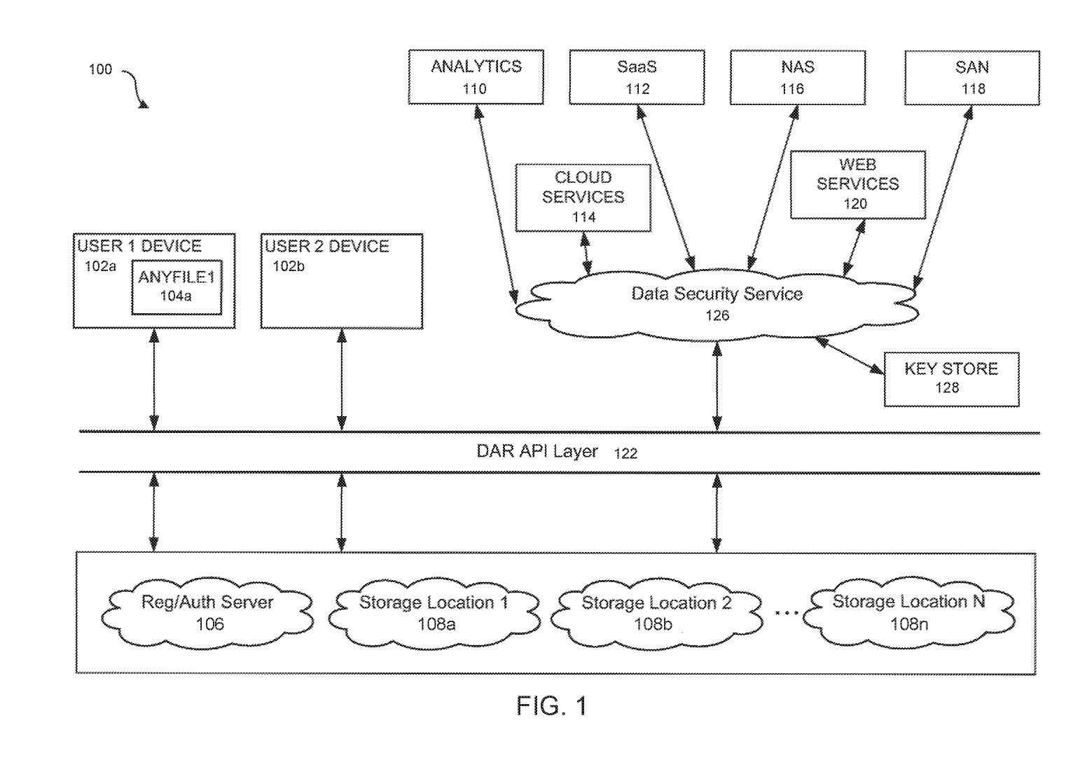

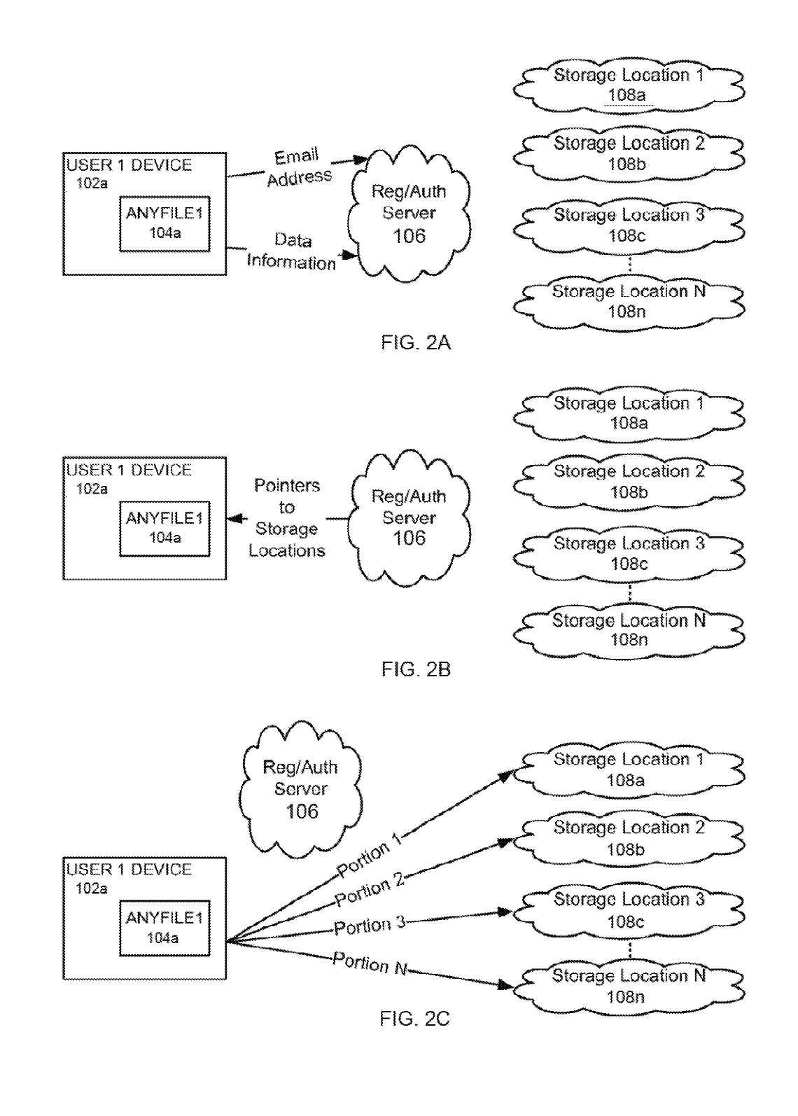

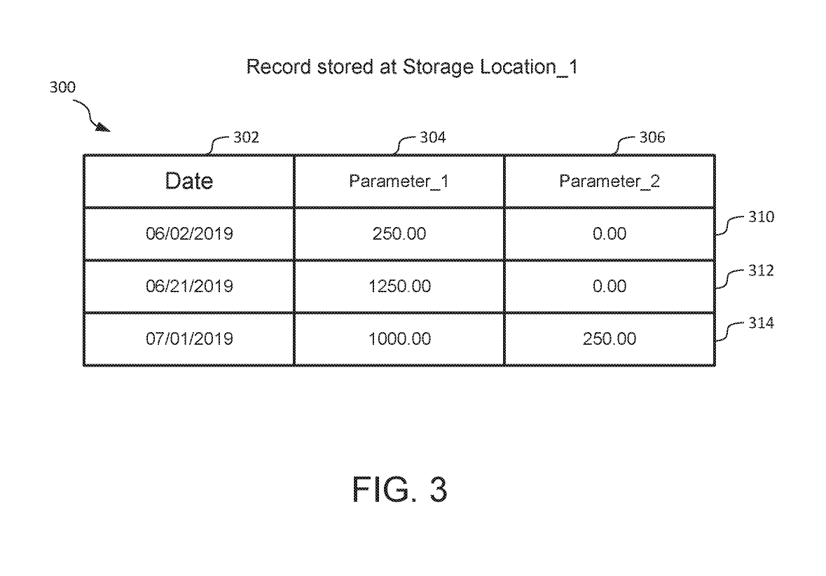

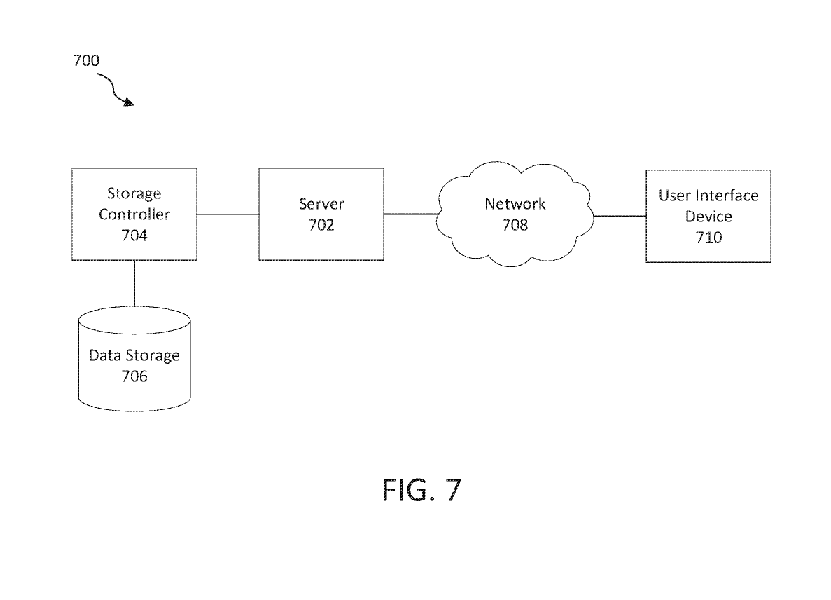

A “console” means a computing system implementing the various method disclosed herein, including but not limited to FIGS. 1-8, 9A, and 9B. A console includes one or more processors and one or more machine readable memory mediums accessible to the processors. The processors and the one or more machine readable mediums of the console are not necessarily located in one physical location and can be connected through internet. In one embodiment, the console is the secure storage system 100 described in FIGS. 1 and 2. In one embodiment, the console implements the methods described in FIGS. 3-6. In another embodiment, the console includes the hardware components described in FIGS. 7-8, 9A, and 9B.

FIG. 1 is a block diagram of a secure storage system 100 for storing electronic records. As used hereafter, the term “data portions” includes data portions parsed from a complete record generated by any information dispersal algorithm (IDA), such as any of the deterministic or probabilistic IDAs described herein, and encrypted before or after being dispersed or otherwise secured. The secure storage system 100 is accessible by multiple user computing devices, such as the User 1 device 102a and the User 2 device 102b. One or more records may be stored in memory on one or more of the user computing devices. These records may be stored as data files (such as ANYFILE 104a), as data objects, or in any other data format. The User 1 device 102a and the User 2 device 102b are in communication (via one or more wireless or wired communications networks, not shown) with the secure storage system 100 via at least one registration/authentication server 106 and one or more of multiple storage locations 108a through 108n. The communication between the user devices 102a and 102b and the secure storage system 100 may be handled though a data-at-rest (DAR) application programming interface (API) Layer 122, as depicted in FIG. 1. The DAR API Layer 122 may, for example, authenticate a user device attempting to access the registration/authentication server 106 or storage locations 108a through 108n. The DAR API Layer 122 also may mediate communications between a user device 102 and the registration/authentication server 106 or storage locations 108a through 108n.

The user devices 102a and 102b may be configured to execute a cryptographic sharing client. Other devices, applications, or networks, such as an Analytics application 110, a SaaS application 112, a Cloud Services application 114, a network storage (NAS) device 116, a storage area network (SAN) 118, and a Web Services application 120, may not be configured to execute cryptographic sharing client. To provide cryptographic sharing and securing functionality to such applications and devices, these applications and devices may communicate with the data security service 126, which includes secure parsing software, such as SPXBITFILER. The data security server 126 is in communication with the registration/authentication server 106 or storage locations 108a through 108n through the DAR API Layer 122.

The data security service 126 stores keys for accessing data stored in the storage locations 108a though 108n in a key store 128. For example, if multiple users of the data security service 126 belong to a workgroup having a workgroup key, the data security service 126 stores the workgroup key in the key store 128 and accesses the key when a user in the workgroup stores or retrieves data from the storage locations 108a through 108n. The storage locations 108a, 108b and 108n preferably include one or more cloud storage locations within a cloud computing environment. In a cloud computing environment, various types of computing services for data sharing, storage, or distribution are provided by a collection of network-accessible computing and storage resources, referred to as “the cloud.” For example, the cloud can include a collection of server computing devices, which may be located centrally or at distributed locations that provide cloud-based services to various types of users and devices connected via a communications network such as the Internet. The storage locations 108a, 108b and 108n may include any suitable local or network-attached storage devices, such as those provided by at least one network storage provider. It will be understood that any suitable number and any suitable types of network storage providers may be used in implementing the one or more storage locations of a secure storage system. In some implementations, such as the implementation illustrated in FIG. 1, a secure storage system includes at least three storage locations (e.g., provided by one or more cloud storage providers). In some implementations, the number of storage locations included in a secure storage system is equal to the number of portions into which data is distributed by a selected IDA (e.g., four storage locations in a 3-of-4 cryptographic split), as described in detail above. The storage locations may be managed by storage provider servers, each of which may be configured to supply storage on-demand and provide upload, download, delete, and list functionality. The storage locations 108a-108n may be collocated with or geographically separated from one or more other storage locations 108a-108n. For example, some storage locations used to store a corporation's data may be located at the corporate headquarters, while other storage locations may be located remotely. Furthermore, all of the storage locations 108a-108n may belong to a single cloud network of a single cloud service provider, or different storage locations may be controlled by different cloud service providers.

The registration/authentication server 106 may be collocated with one or more of the storage locations 108a-108n, or it may be geographically separated from one or more of the storage locations 108a-108n. The registration/authentication server 106 includes one or more processors configured to register users of the secure storage system 100 (including individual users, user devices, and groups of users or devices), store user credentials such as e-mail addresses or usernames, authenticate users (e.g., based on the stored credentials), look up users by their e-mail address or other credentials, transmit a public key to a cryptographic sharing client, de-authorize one or more users from accessing the registration/authentication server 106, accept payment for use of one or more aspects of the secure storage system 100, and enforce the expiration of a user's access to the secure storage system 100. The registration/authentication server 106 is also configured to direct users or user devices to one or more of the storage locations 108a-108n for writing data or for retrieving data. In particular, if data that a user device requests to retrieve has been portioned in accordance with an M of N technique (one in which M portions of N stored portions are needed to reassemble or restore a data set to its original or usable form, with M less than N), the registration/authentication server 106 is configured to identify and return to the user device information about M recommended storage locations from among the storage locations 108a-108n. The user device can then use this information to selectively access storage locations to retrieve the desired data. These and other functions of registration/authentication server 106 are described in further detail below.

In some implementations, the secure storage system 100 includes multiple registration/authentication servers (like registration/authentication server 106). Multiple registration/authentication servers each may all perform all of the registration, authentication, and directing functions described herein, or different registration/authentication server functions may be performed by different registration/authentication servers. In some embodiments, each registration/authentication server is in communication with a different set of user devices and/or storage locations 108a-108n. Registration/authentication servers may share data with other registration/authentication servers.

FIGS. 2A-C are block diagrams depicting an implementation of secure data storage in the system of FIG. 1. In FIG. 2A, the User 1 device 102a registers with the secure storage system 100 via the registration/authentication server 106. During the initial registration of the User 1 device 102a, the User 1 device 102a may transmit to the registration/authentication server 106, information identifying the device itself (such as a MAC address or other device-identifying information) or information identifying the user (User 1) associated with the User 1 device 102a. For example, as shown in FIG. 2A, the User 1 device 102a may transmit an e-mail address associated with User 1. The registration/authorization server 106 may also generate user authorization data (not shown) that is associated with User 1 or with the User 1 device 102a. The authorization data is transmitted to the User 1 device 102a and is stored by the User 1 device 102a. The User 1 device 102a can then transmit this authorization data to the registration/authorization server 106 so that the registration/authorization server 106 will authorize the User 1 device 102a to perform additional operations on data stored in the secure storage system (e.g., writing, reading, and modifying operations).

User 1 or the User 1 device 102a may be associated with a group, enterprise, or product. In such embodiments, the registration/authentication server 106 may also store any suitable group information that may define a group of users or user devices (e.g., by usernames or other identifying information or by user device identification information). Group affiliations may be provided to the registration/authentication server 106 when the user device communicates with the registration/authentication server 106. For example, a group to which a user device belongs may be indicated by a sender of a secure e-mail when attempting to transmit data to other members of the group. In some implementations, the user devices that access registration/authentication server 106 may be designated using access groups such as “sharing” workgroups. In some implementations, a workgroup or collection of users or user devices may share a private workgroup key and corresponding public key.

To store a file in the secure storage system 100, User 1 uses User 1 device 102a to select a data set to be stored (as shown in FIG. 2A, ANYFILE1 104a) and transmits information about the selected data set to the registration/authentication server 106. The information about the selected data set may include a name or other identifier of the data set, a data type of the data set, a size of the data set, the number of portions into which the data set has been distributed within the User 1 device 102a (e.g., per any of the share generation techniques described herein) or any other information that the registration/authentication server 106 is configured to use to determine where to store a data set or where to find a data set that has previously been stored and is now being updated. In some implementations, the data set to be stored is automatically identified by the User 1 device 102a (e.g., as part of an automated backup process).

Upon receiving the information about the data set to be stored, the registration/authentication server 106 transmits pointers to the storage locations 108a-108n in which the User 1 device 102a can store portions of the data set, as shown in FIG. 2B. These pointers may include any information that allows a user device to identify a location in which accessible data is stored or may be stored, such as an IP address of a storage location, a memory location (e.g., a data block number or range of data block numbers), a storage path indicating where data is stored within the storage location, or any combination of such information. Each time data is transmitted to the secure storage system 100, or on a periodic or other time schedule, the user device transmitting the data for storage receives one or more pointers identifying the storage locations to which data should be written.

This approach may provide several benefits. First, if one or more storage locations has moved (e.g., if a storage location previously on a server in a first city has been transferred to a server in a second city) or been replaced (e.g., if data in a storage location is transferred from an old server to a new server having a different IP address) since the last time the user device wrote to or otherwise accessed the storage location, the registration/authentication server 106 provides updated pointers that may prevent the user device from relying on outdated, locally stored pointers from a previous time of access. Second, if one or more storage locations that had been previously used by the user device (or an enterprise or product with which the user device is associated) is unavailable, the registration/authentication server 106 does not provide pointers to the unavailable storage locations, but instead may identify fewer storage locations or different storage locations to which data shares should be written. By maintaining or determining storage location availability information at the registration/authentication server 106, a user device does not have to waste resources pinging potentially unavailable storage locations or attempting to write to potentially unavailable storage locations. Further, by providing storage location availability information only when a user device requests to interact with a storage location (e.g., write to the storage location, read from the storage location, or modify data stored at the location), the secure storage system avoids sending unneeded data to the user device, and the user device avoids receiving storage location availability data from the secure storage system when it is not needed.

FIG. 2C shows the User 1 device 102 a transmitting N shares of encrypted data (Share 1-Share N) via a communication network (e.g., a wired or wireless network) to N storage locations 108a-108n, respectively, that the registration/authentication server 106 has determined are available. The storage locations 108a-108n are identified by the pointers received by User 1 device 102a, as shown in FIG. 2B.

FIG. 3 shows an example of automatic parameter adjusting of a record 300 stored at a storage location according to one embodiment of the disclosure. It is noted the example shown in FIG. 3 is illustrative and does not limit scope of the disclosure in anyway.

The record 300 includes three columns Column 302 includes entries about dates associated with parameter_1 and parameter_2. Column 304 includes parameter_1 of the record. Column 306 includes parameter_2 of the record. As shown in FIG. 3, the record 300 is presented in a table format. In one embodiment, the record 300 can be a financial balance sheet. In another embodiment, the column 304 can be a first account balance and column 306 can be a second account balance.

In another embodiment, the record 300 may have multiple parameters, e.g., parameter_1, parameter_2 . . . parameter_N, where N can be any positive integer. In another embodiment, the record 300 may not be in a table form. In another embodiment, the record may not include a date column.

As shown in FIG. 3, the record 300 includes parameters [row, column]=[310, 302]=“Jun. 2, 2019,” [312, 302]=“Jun. 21, 2019,” and [314, 302]=“Jul. 1, 2019.” The record further includes parameters [row, column]=[310, 304]=“250,” [312, 304]=“1250,” [314, 304]=“1000.” The record further includes parameters [row, column]=[310, 306]=“0,” [312, 306]=“0,” [314, 306]=“250.”

Specific rules exist in adjusting the parameter_1 304 and parameter_2 306. In one embodiment, one rule can be that parameter_1 has a first threshold. If parameter_1 is over the first threshold, the value over the first threshold is moved to parameter_2, wherein the sum of parameter_1 and parameter_2 remains the same before and after the adjustment. For example, the first threshold for parameter_1 304 is 1000. [Parameter_1, Parameter_2] started on Jun. 2, 2019 at [250, 0]. On Jun. 21, 2019, [Parameter_1, Parameter_2] becomes [1250, 0.00], where parameter_1 is over the first threshold.

In one embodiment, parameter_1 can be a checking account balance and parameter 2 can be a savings account balance of a user. The first threshold may be a checking account cap set by the user. Here in FIG. 3, this cap is a thousand dollar. This means if the checking account balance is over a thousand dollar, the excessive amount is moved to the savings account.

There may be another rule about when the adjustment is made. Here in FIG. 3, the adjustment is made on the first of the following month that parameter_1 surpassed the threshold. Thus, on Jul. 1, 2019, the value that is over the first threshold 1000 of parameter_1 is moved to parameter_2, where the summation of parameter_1 and parameter_2 remain the same before and after the move.

In the example of FIG. 3, the record 300 is stored at one location, i.e., storage location_1. In other embodiments, the record 300 can be first parsed in multiple pieces, then encrypted with different keys, and finally stored in different locations as shown in FIG. 1 and FIG. 2. The adjustments of the parameters can be done directly among the stored locations without send that record back to the user device for processing. This direct processing of record parameters effectively reduces the internet congestion as well as reduces consumption of computational resources. In another embodiment, the Parameter_2 may have a second threshold, wherein if parameter_2 is over the second threshold, then the system will stop moving the amount from parameter_1 to the parameter_2. In one embodiment, the second threshold is a saving goal for the savings account, e.g., the parameter_2. Once, the saving goal is met, the system stops moving money from the checking account, e.g., the parameter_1, to the savings account.

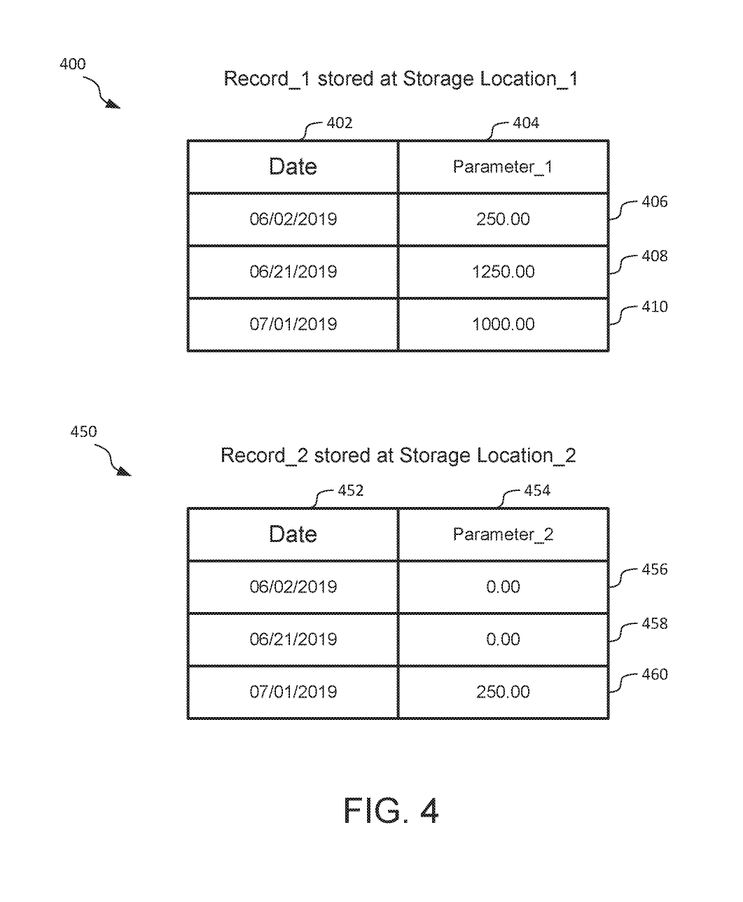

FIG. 4 shows an example of automatic parameter adjusting of two records stored at different locations according to one embodiment of the disclosure.

FIG. 4 shows an example of automatic parameter adjusting of records 400, 450 stored at different storage locations according to one embodiment of the disclosure. In one embodiment, record 400 and record 450 can be understood as two separate records storing at different storage locations. In another embodiment, records 400 and 450 are two datasets parsed from the record 300 in FIG. 3. The parsing and distribution methods described in FIGS. 1, 2A, 2B, and 2C are all applicable in parsing the record 300 into records 400 and 450.

The following description of FIG. 4 refers to record 400 and record 450 as two separate records. But, it is noted that records 400 and 450 can also be understood as two datasets parsed from the record 300. FIG. 4 is illustrative and does not limit scope of the disclosure in anyway.

The records 400, 450 each includes two columns. Record 400 includes columns 402 (date) and 404 (parameter_1). Record 450 includes columns 452 (date) and 454 (parameter_2). The date columns 402 and 452 are repetitive. Each dates can be expressed as [row, column]: [406, 402]=[456, 452]=Jun. 2, 2019; [408, 402]=[458, 452]=Jun. 21, 2019; and [410, 402]=[460, 452]=Jul. 1, 2019.

Record 400 further includes column 404 which represents Parameter_1. Each Parameter_1 can be expressed as [row, column]: [406, 404]=[250.00]; [408, 404]=[1250.00]; and [410, 404]=[1000.00].

Record 450 further includes column 454 which represents Parameter_1. Each Parameter_1 can be expressed as [row, column]: [456, 454]=[0.00]; [458, 454]=[0.00]; and [460, 454]=[250.00].

Specific rules exist in adjusting the parameter_1 404 and parameter_2 454. In one embodiment, one rule can be that parameter_1 has a first threshold. If parameter_1 is over the first threshold, the value over the first threshold is moved to parameter_2, wherein the sum of parameter_1 and parameter_2 remains the same before and after the adjustment. For example, the first threshold for parameter_1 404 can be 1000. [Parameter_1, Parameter_2] started on Jun. 2, 2019 at [250, 0]. On Jun. 21, 2019, [Parameter_1, Parameter_2] becomes [1250, 0.00], where parameter_1 is over the first threshold of 1000. There may be another rule about the timing of the adjustment being made. Here in FIG. 4, the adjustment is made on the first of the following month that parameter_1 surpassed the threshold. Thus, on Jul. 1, 2019, the value of parameter_1 over the first threshold 1000 is moved to parameter_2, where the summation of parameter_1 and parameter_2 remain the same before and after the move.

In one embodiment, parameter_1 404 can be a checking account balance and parameter_2 454 can be a savings account balance of a user. The first threshold may be a checking account cap set by the user. Here in FIG. 4, this cap is a thousand dollar. This means if the checking account balance (e.g., parameter_1 404) is over a thousand dollar, the excessive amount is moved to the savings account (e.g., parameter_2 454).

In the example of FIG. 4, the records 400 and 450 are stored at different locations, i.e., storage location_1 and storage location_2, respectively. In other embodiments, the records 400 and 450 are parsed pieces of another record. Each of the record 400 and 450 can be encrypted with different keys, and stored in different locations as shown in FIG. 1 and FIG. 2.

In another embodiment, the Parameter_2 may have a second threshold, wherein if parameter_2 is over the second threshold, then the system will stop moving the amount from parameter_1 to the parameter_2. In one embodiment, the second threshold is a saving goal for the savings account, e.g., the parameter_2. Once, the saving goal is met, the system stops moving money from the checking account, e.g., the parameter_1, to the savings account.

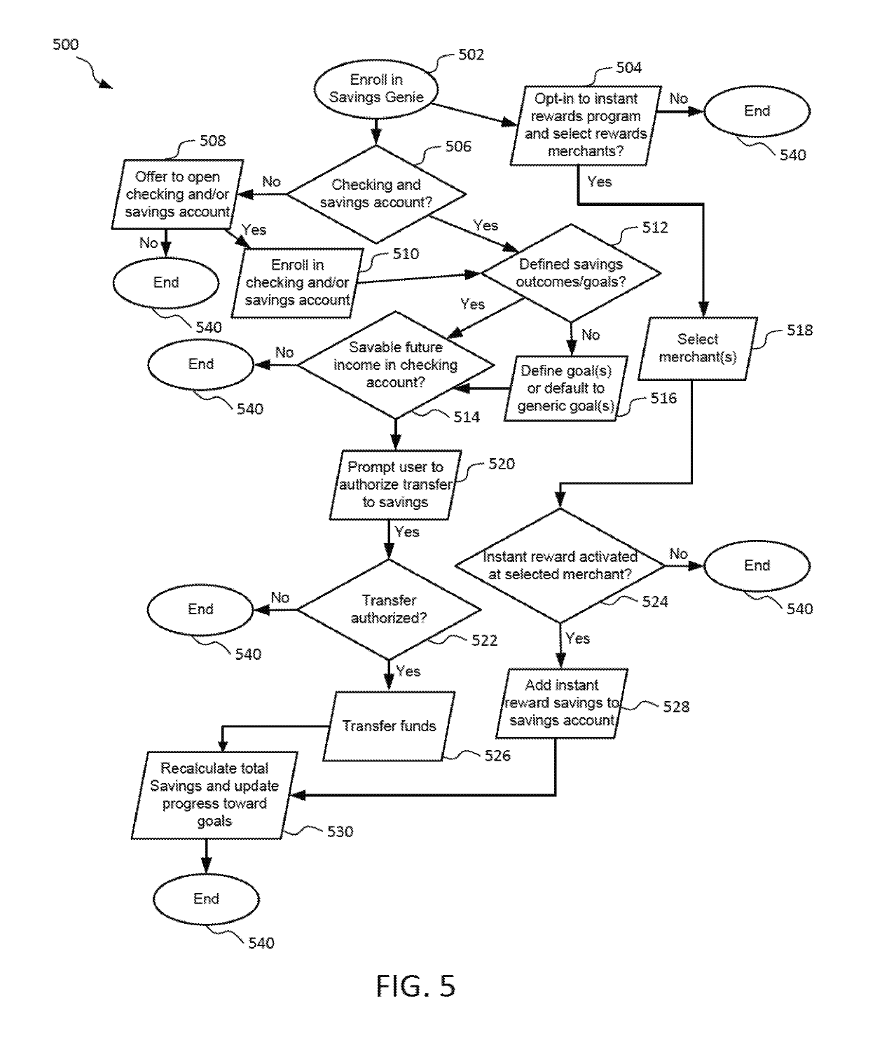

FIG. 5 shows a method 500 of automatic parameter adjusting of records according to one embodiment of the disclosure.

The method 500 starts at 502 which includes enrolling in savings genie. Saving genie is a financial service. The method 500 moves from 502 to both 504 and 506. Step 504 includes opting-in to instant rewards program and select rewards merchants. Step 506 includes determining, whether checking and savings account are both enrolled in the savings genie.

The method moves from 504 to 540 if user does not opt-in to instant rewards program and select rewards merchants. 540 is termination of method 500. The method moves from 504 to 518, if client opted-in. 518 allows the user to select merchants 518.

The method 500 moves from 518 to 524, which determines whether instant reward is activated. If instant reward is not activated at 524, the method 500 terminates at 540. If instant reward is activated at 524, the method 500 moves to 528, which adds instant reward savings to user's savings account. In one embodiment, if a user made a purchase with a selected merchant, the method 500 would contribute a percentage, e.g., 1%, of the purchase price to the user's savings account.

The method 500 moves from 528 to 530, which recalculates total savings and update progress toward goals. In one embodiment, the goals may be a threshold, similar to the second threshold of parameter_2 discussed in FIG. 3 and FIG. 4.

The method 500 can move from 502 to 506, which determines whether checking and savings accounts are included. If “no” at 506, the method 500 offers at 508 to open a checking account and/or savings account. If “yes” at 506, the method 500 moves to 512, which includes determining whether the user defined a savings or outcome goal. In one embodiment, the saving goal can be the second threshold of parameter_2 in FIG. 3 and FIG. 4.

If “no” at 512, the method 500 may automatically set a goal or default to a generic goal for the user. If “yes” at 512, the method 500 moves to 514, which determines whether the user has savable future income in checking account. In one embodiment, at 514, the method 500 analyzes the income pattern and expense pattern of the user to determine whether the user has potential savable future income. This may include searching for salary auto-deposit data and expense data in the past.

In one embodiment, at 514, the method 500 sets a first threshold for the checking account, similar to the first threshold of parameter_1 in FIG. 3 and FIG. 4. When the amount of a checking account is over the first threshold, the excessive amount is automatically moved to savings account.

If “no” at 514, the method 500 terminates at 540. If “yes” at 514 meaning there are potential savable income, the method 500 moves from 514 to 520, which prompts user to authorize instant or future transfer of funds. This may include transferring a fixed amount or a fixed portion of the future income from checking to saving.

The method 500 moves from 520 to 522, which determines whether transfer authorization is completed. If “no” at 522, the method 500 terminates at 540. If “yes” at 522, the method 500 executes the transfer as planned at 526. The method 500 moves from 526 to 530, which recalculate total savings and update progress toward the goal at 540.

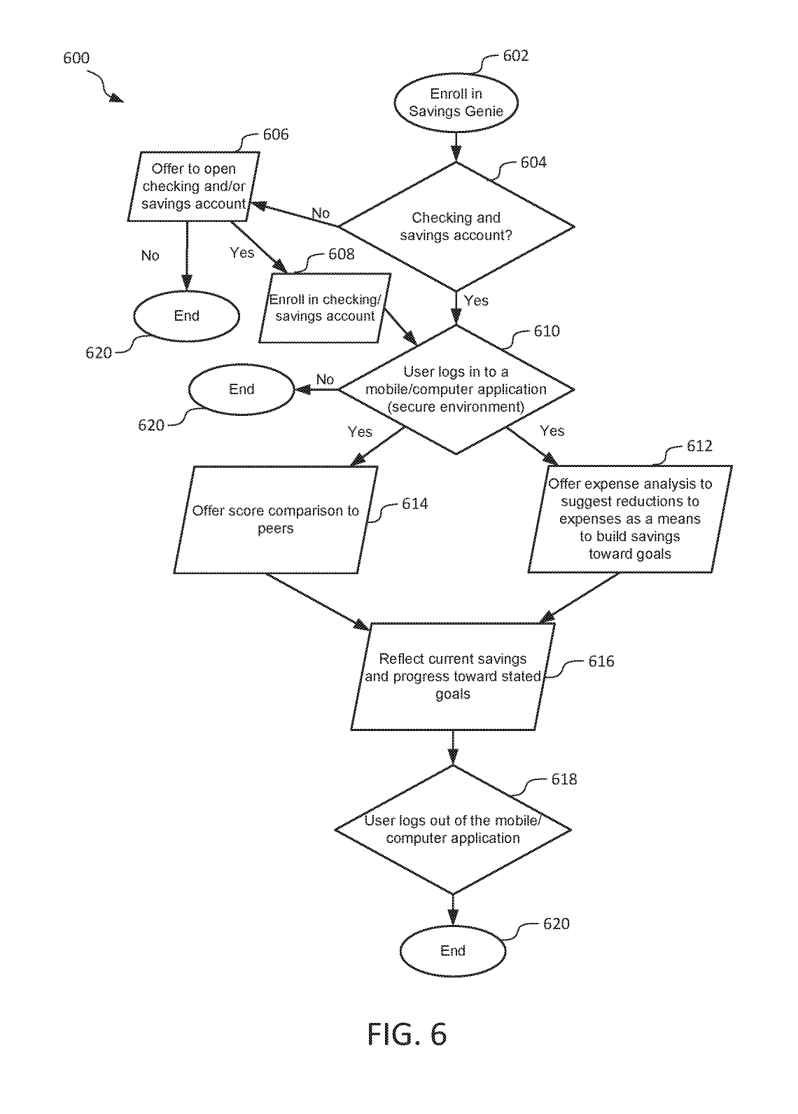

FIG. 6 shows a method 600 of automatic parameter adjusting of records according to one embodiment of the disclosure. The method 600 starts at 602, which enrolls the user to savings genie, wherein the savings genie is a financial service.

The method 600 moves from 602 to 604, which determines whether the user has a checking and a savings accounts. If “no” at 604, the method 600 moves to 606, which offers to open checking and/or savings account. If “yes” at 604, the method 600 moves to 610, which determines whether user logs in to a mobile/computer application. The mobile/computer application can be specific for implementing the savings genie.

If “no” at 610, the method 600 terminates at 620. If “yes” at 610, the method 600 moves to 612 and 614. At 612, the method 600 offers expense analysis to suggest reductions to expenses as a means to build savings toward goals. Step 612 can be incorporated in step 514 in determining potential savable income. At 614, the method 600 offers score comparison to the user's peers.

The method 600 moves from both 612 and 614 to 616, which reflects current savings and progress toward stated goals. The method 600 moves from 616 to 618, which allows user to log off the mobile/computer application. The method 600 moves from 618 to 620, which terminates the method 600. Fse

FIG. 7 illustrates a computer network 700 for obtaining access to database files in a computing system according to one embodiment of the disclosure. The computer network 700 may include a server 702, a data storage device 706, a network 708, and a user interface device 710. The server 702 may also be a hypervisor-based system executing one or more guest partitions hosting operating systems with modules having server configuration information. In a further embodiment, the computer network 700 may include a storage controller 704, or a storage server configured to manage data communications between the data storage device 706 and the server 702 or other components in communication with the network 708. In an alternative embodiment, the storage controller 704 may be coupled to the network 708.

In one embodiment, the user interface device 710 is referred to broadly and is intended to encompass a suitable processor-based device such as a desktop computer, a laptop computer, a personal digital assistant (PDA) or tablet computer, a smartphone or other mobile communication device having access to the network 708. In a further embodiment, the user interface device 710 may access the Internet or other wide area or local area network to access a web application or web service hosted by the server 702 and may provide a user interface for enabling a user to enter or receive information.

The network 708 may facilitate communications of data between the server 702 and the user interface device 710. The network 708 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

In one embodiment, the user interface device 710 accesses the server 702 through an intermediate sever (not shown). For example, in a cloud application the user interface device 710 may access an application server. The application server fulfills requests from the user interface device 710 by accessing a database management system (DBMS). In this embodiment, the user interface device 710 may be a computer or phone executing a Java application making requests to a JBOSS server executing on a Linux server, which fulfills the requests by accessing a relational database management system (RDMS) on a mainframe server.

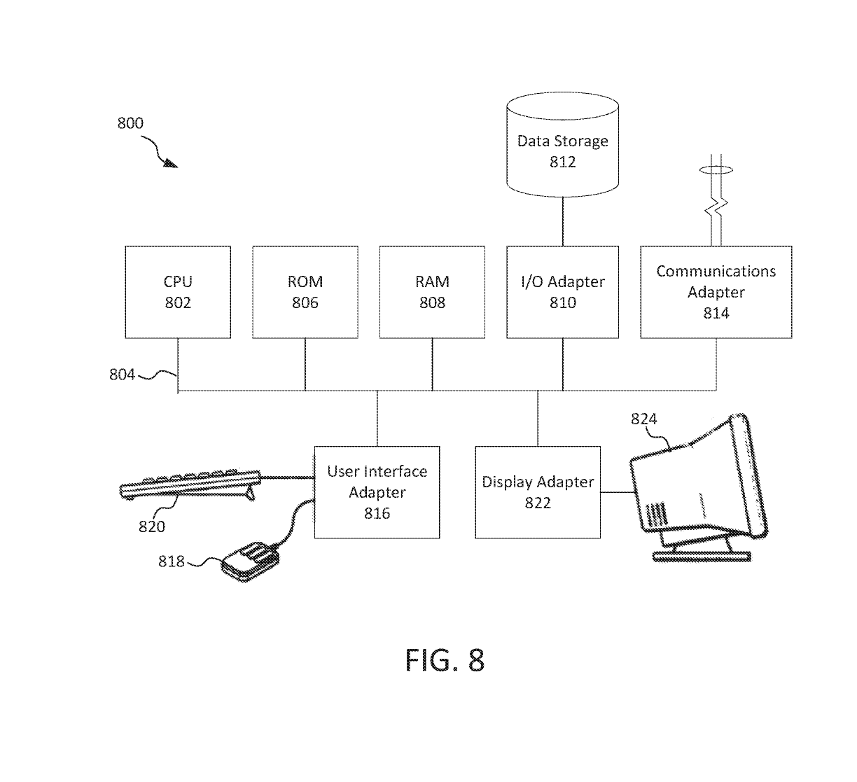

FIG. 8 illustrates a computer system 800 adapted according to certain embodiments of the server 802 and/or the user interface device 810. The central processing unit (“CPU”) 802 is coupled to the system bus 804. The CPU 802 may be a general purpose CPU or microprocessor, graphics processing unit (“GPU”), and/or microcontroller. The present embodiments are not restricted by the architecture of the CPU 802 so long as the CPU 802, whether directly or indirectly, supports the operations as described herein. The CPU 802 may execute the various logical instructions according to the present embodiments.

The computer system 800 may also include random access memory (RAM) 808, which may be synchronous RAM (SRAM), dynamic RAM (DRAM), synchronous dynamic RAM (SDRAM), or the like. The computer system 800 may utilize RAM 808 to store the various data structures used by a software application. The computer system 800 may also include read only memory (ROM) 806 which may be PROM, EPROM, EEPROM, optical storage, or the like. The ROM may store configuration information for booting the computer system 800. The RAM 808 and the ROM 806 hold user and system data, and both the RAM 808 and the ROM 806 may be randomly accessed.

The computer system 800 may also include an I/O adapter 810, a communications adapter 814, a user interface adapter 816, and a display adapter 822. The I/O adapter 810 and/or the user interface adapter 816 may, in certain embodiments, enable a user to interact with the computer system 800. In a further embodiment, the display adapter 822 may display a graphical user interface (GUI) associated with a software or web-based application on a display device 824, such as a monitor or touch screen.

The I/O adapter 810 may couple one or more storage devices 812, such as one or more of a hard drive, a solid state storage device, a flash drive, a compact disc (CD) drive, a floppy disk drive, and a tape drive, to the computer system 800. According to one embodiment, the data storage 812 may be a separate server coupled to the computer system 1000 through a network connection to the I/O adapter 810. The communications adapter 814 may be adapted to couple the computer system 800 to the network 708, which may be one or more of a LAN, WAN, and/or the Internet. The user interface adapter 816 couples user input devices, such as a keyboard 820, a pointing device 818, and/or a touch screen (not shown) to the computer system 800. The display adapter 822 may be driven by the CPU 802 to control the display on the display device 824. Any of the devices 802-822 may be physical and/or logical.

The applications of the present disclosure are not limited to the architecture of computer system 800. Rather the computer system 800 is provided as an example of one type of computing device that may be adapted to perform the functions of the server 702 and/or the user interface device 710. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 800 may be virtualized for access by multiple users and/or applications.

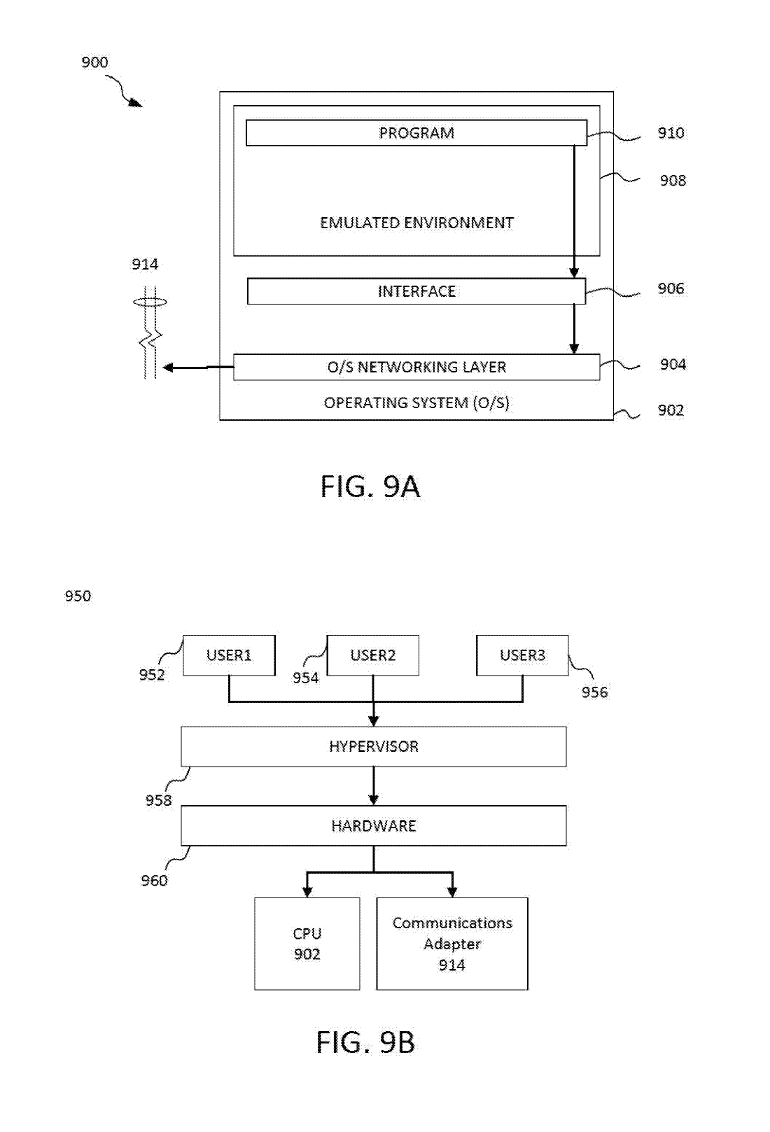

FIG. 9A is a block diagram illustrating a server 900 hosting an emulated software environment for virtualization according to one embodiment of the disclosure. An operating system 902 executing on a server 900 includes drivers for accessing hardware components, such as a networking layer 904 for accessing the communications adapter 914. The operating system 902 may be, for example, Linux or Windows. An emulated environment 908 in the operating system 902 executes a program 910, such as Communications Platform (CPComm) or Communications Platform for Open Systems (CPCommOS). The program 910 accesses the networking layer 904 of the operating system 902 through a non-emulated interface 906, such as extended network input output processor (XNIOP). The non-emulated interface 906 translates requests from the program 910 executing in the emulated environment 908 for the networking layer 904 of the operating system 902.

In another example, hardware in a computer system may be virtualized through a hypervisor. FIG. 9B is a block diagram illustrating a server 950 hosting an emulated hardware environment according to one embodiment of the disclosure. Users 952, 954, 956 may access the hardware 960 through a hypervisor 958. The hypervisor 958 may be integrated with the hardware 960 to provide virtualization of the hardware 960 without an operating system, such as in the configuration illustrated in FIG. 9A. The hypervisor 958 may provide access to the hardware 960, including the CPU 802 and the communications adaptor 914.

If implemented in firmware and/or software, the functions described above may be stored as one or more instructions or code on a computer-readable medium. Examples include non-transitory computer-readable medium encoded with a data structure and computer-readable medium encoded with a computer program. Computer-readable medium includes physical computer storage media. A storage medium may be any available medium that can be accessed by a computer. By way of example, and not limitation, such computer-readable medium can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable medium.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A computing machine comprising:
a processor;
a machine readable medium accessible by the processor;
a record stored in the machine readable medium, the record including a first parameter and a second parameter; and
the processor being adapted to execute instructions including
setting a first threshold for the first parameter;
evaluating an increase of the first parameter; and
moving an amount of the increase of the first parameter excessive to the first threshold to the second parameter, wherein a summation of the first parameter and the second parameter remains the same before and after the movement.

2. The computing machine according to claim 1, wherein the processor being adapted to further execute instruction including
setting a second threshold for the second parameter; and
stopping any movement of any portion of the first parameter to the second parameter, if the second parameter is equal or larger than the second threshold.

3. The computing machine according to claim 1, wherein the processor being adapted to further execute instruction including
parsing the record into two or more data pieces, a first data piece including the first parameter, a second data piece including the second parameter;
encrypting the first data piece with a first key; and
encrypting the second data piece with a second key.

4. The computing machine according to claim 3, wherein the processor being adapted to further execute instruction including
storing the first data piece at a first storage location; and
storing the second data piece at a second storage location.

5. The computing machine according to claim 1, wherein the processor being adapted to further execute instruction including
evaluating a pattern of change of the second parameter.

6. The computing machine according to claim 1, wherein the processor being adapted to further execute instruction including
encrypting the record with a key.

7. The computing machine according to claim 1, wherein the processor being adapted to further execute instruction including
adding an amount to the second parameter, wherein a summation of the first parameter and the second parameter after the add is larger than a summation before the add.

8. A machine readable medium of a computing machine, comprising
a record stored in the machine readable medium, the record including a first parameter and a second parameter; and
the machine readable medium further including instructions when executed cause a processor of the console to perform the following actions:
setting a first threshold for the first parameter;
evaluating an increase of the first parameter; and
moving an amount of the increase of the first parameter excessive to the first threshold to the second parameter, wherein a summation of the first parameter and the second parameter remains the same before and after the movement.

9. The machine readable memory medium according to claim 8 further including instructions:
setting a second threshold for the second parameter; and
stopping any movement of any portion of the first parameter to the second parameter, if the second parameter is equal or larger than the second threshold.

10. The machine readable memory medium according to claim 8 further including instructions:
parsing the record into two or more data pieces, a first data piece including the first parameter, a second data piece including the second parameter;
encrypting the first data piece with a first key; and
encrypting the second data piece with a second key.

11. The machine readable memory medium according to claim 10 further including instructions:
storing the first data piece at a first storage location; and
storing the second data piece at a second storage location.

12. The machine readable memory medium according to claim 8 further including instructions:
evaluating a pattern of change of the second parameter.

13. The machine readable memory medium according to claim 8 further including instructions:
encrypting the record with a key.

14. The machine readable memory medium according to claim 8 further including instructions:
adding an amount to the second parameter, wherein a summation of the first parameter and the second parameter after the add is larger than a summation before the add.
